(19) United States
(12) Patent Application Publication
(10) Pub. No.: US 2022/0226846 A1
(43) Pub. Date: Jul. 21, 2022

(54) WATER SPRAYER HEAD

(71) Applicant: SHIN TAI SPURT WATER OF THE GARDEN TOOLS CO., LTD, Chang-hua Hsien (TW)

(72) Inventor: Chin-Yuan Chen, CHANG-HUA HSIEN (TW)

(21) Appl. No.: 17/151,470

(22) Filed: Jan. 18, 2021

(51) Int. Cl. B05B 9/01; B05B 1/10

(52) U.S. Cl. CPC B05B 9/01; B05B 1/10

(57) ABSTRACT

A water sprayer head has a guiding base and a positioning cover. The guiding base has a main body with a plurality of guiding columns, each guiding column having a respective central guiding hole and at least one distributing aperture at a front end connected to the guiding hole, a diameter of the distributing aperture being smaller than a diameter of the guiding hole. The positioning cover has a front end portion and a rear end portion, the rear end portion has a plurality of sleeve holes corresponding to the number and positions of the guiding columns, each sleeve hole has at least one aperture passing through the front end portion and having a diameter smaller than the diameter of the respective distributing aperture.

### BACKGROUND OF INVENTION

### Field of Invention

The present invention relates to a water sprayer head.

### Description of Related Art

Normally, it is necessary to water frequently in gardening work to prevent plants from dying due to lack of water, but plants are usually planted in a wide range or far from the water source, so water pipes connecting the gardening spray gun are often used in the watering process. Although the typical known gardening spray gun usually has a variety of different spray shapes to choose, the spray gun still cannot spray mist for certain plants, which is also impossible to achieve more water-saving and more uniform spread.

Therefore, it is desirable to provide a water sprayer head to mitigate and/or obviate the aforementioned problems.

### SUMMARY OF INVENTION

An objective of present invention is to provide a water sprayer head, which is capable of improving the above-mention problems.

In order to achieve the above mentioned objective, a water sprayer head has a guiding base and a positioning cover. The guiding base has a main body with a plurality of guiding columns, each guiding column having a respective central guiding hole and at least one distributing aperture at a front end connected to the guiding hole, a diameter of the distributing aperture being smaller than a diameter of the guiding hole. The positioning cover has a front end portion and a rear end portion, the rear end portion has a plurality of sleeve holes corresponding to the number and positions of the guiding columns, each sleeve hole has at least one aperture passing through the front end portion and having a diameter smaller than the diameter of the respective distributing aperture.

Other objects, advantages, and novel features of invention will become more apparent from the following detailed description when taken in conjunction with the accompanying drawings.

### BRIEF DESCRIPTION OF DRAWINGS

FIG. 1 is a three-dimensional exploded view of a preferred embodiment according to the present invention.

FIG. 2 is the combination drawing of this preferred embodiment according to the present invention.

FIG. 3 is the implementation state drawing of the preferred embodiment installed on the gardening spray gun according to the present invention.

FIG. 4 is a cross-sectional view of the preferred embodiment spraying water into a mist according to the present invention.

FIG. 5 is a three-dimensional drawing of the preferred embodiment spraying water into a mist.

### DETAILED DESCRIPTION OF PREFERRED EMBODIMENT

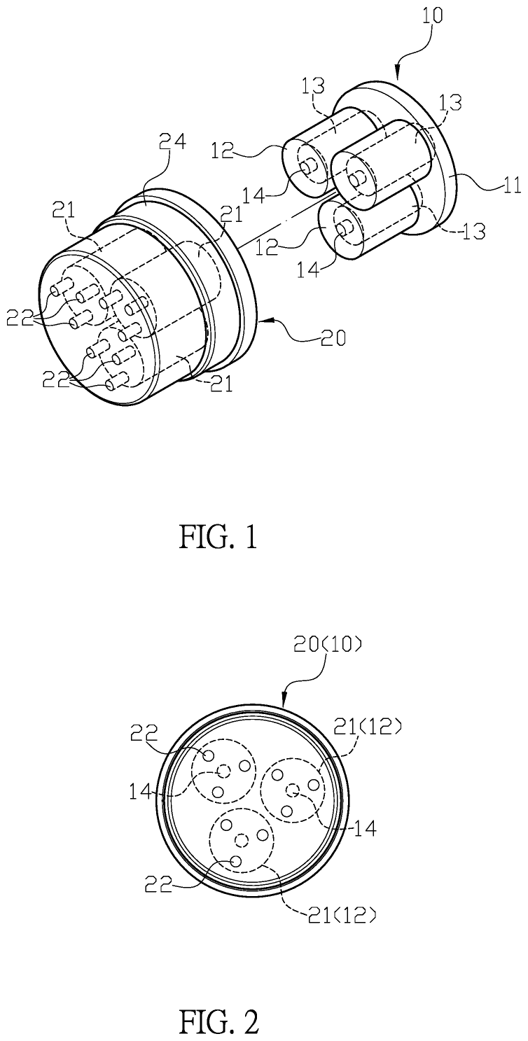

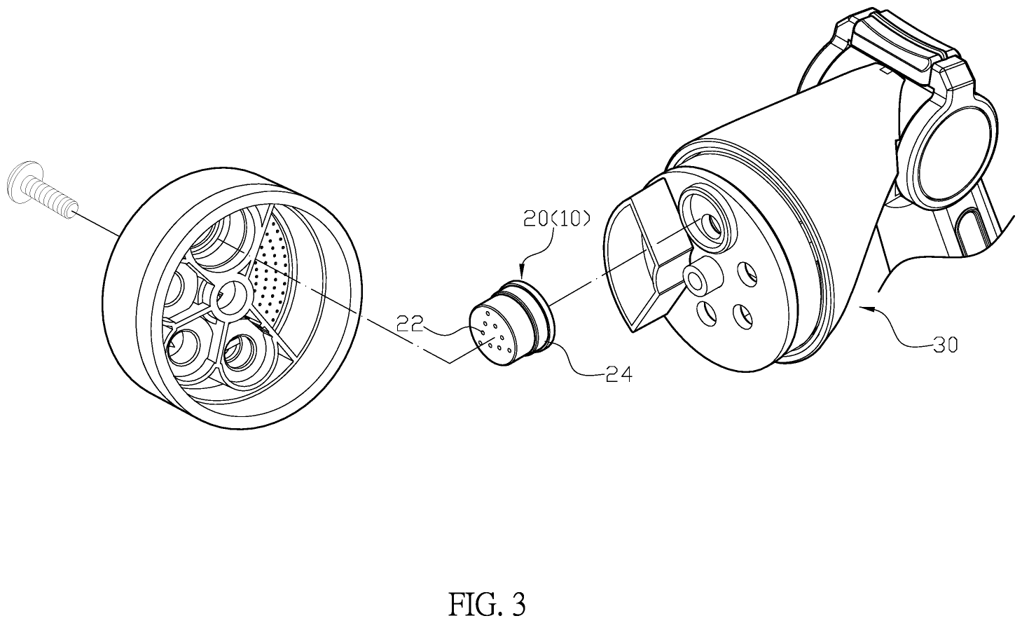

Please refer to FIGS. 1 and 2. The water sprayer head comprises a guiding base 10 and a positioning cover 20. The guiding base 10 has a main body 11 with a plurality of guiding columns 12, each guiding column 12 having a respective central guiding hole 13 and at least one distributing aperture 14 at a front end connected to the guiding hole 13. When water enters into the guiding hole 13 through the guiding column 12 and exits from the distributing aperture 14. A diameter of the distributing aperture 14 is smaller than a diameter of the guiding hole 13, so the water is more refined. The positioning cover 20 has a front end portion and a rear end portion, the rear end portion has a plurality of sleeve holes 21 corresponding to the number and positions of the guiding column 12. Each sleeve hole 21 has at least one micro aperture 22 passing through the front end portion and having a diameter smaller than the diameter of the respective distributing aperture 14. The micro aperture 22 refines the water even more before spraying it out, so the water sprayer head can provide misty spray.

Furthermore, the main body 11 of the guiding base 10 is a round disk.

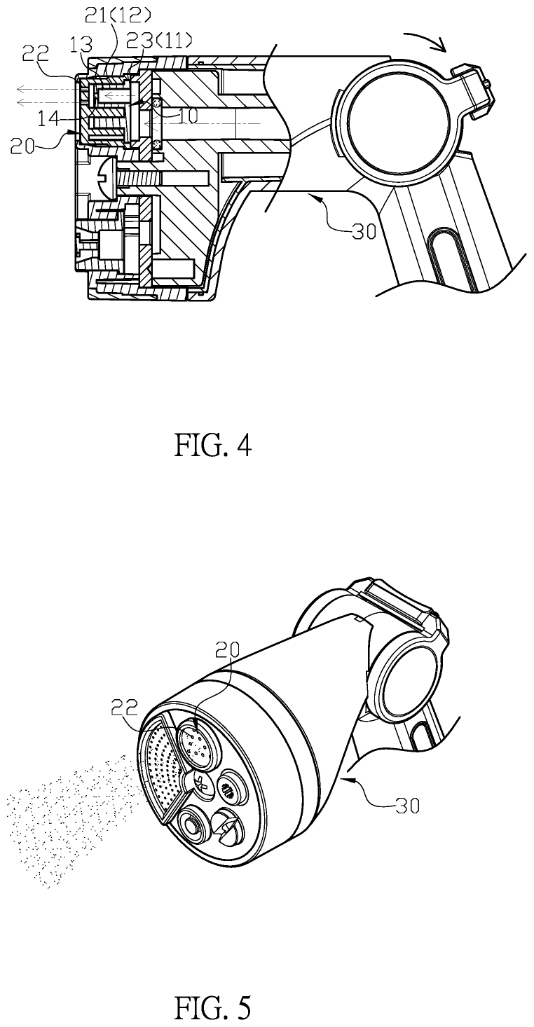

Moreover, the rear end portion of the positioning cover 20 is provided with a groove 23 configured to accept the main body 11 of the guiding base 10, as shown in FIG. 4.

In addition, t a periphery of the positioning cover has a flange 24 for securing on to water equipment 30.

Also, the water equipment 30 is a gardening sprayer.

Additionally, the water equipment 30 is a long spray gun.

As well, the water equipment 30 is a ground sprinkler.

Moreover, the guiding column 12 of the guiding base 10 and the sleeve hole 21 of the positioning cover 20 both have a number of three.

In addition, each sleeve hole 21 has three micro apertures 22 passing through the front end portion of the positioning cover 20.

Likewise, the number of the micro aperture 22 can be changed to change the flux and distribution area of the water sprayer head.

In actual use, the water sprayer head is installed on the water equipment 30. In this embodiment a gardening multi-stage spray gun is used as an example for the water equipment 30, but it is not limited to this. Please also refer to FIG. 3 to FIG. 5, the guiding holes 13, the distributing apertures 14 and the micro apertures 22 together provide a water channel for the water to pass through, and the difference diameters of the holes and the apertures, the water can be sufficiently refined, and then sprayed in a mist-like spray. Therefore, it can prevent the spray particles from being too large to damage or over-water the plants, and it can also achieve more water-saving and more uniform distribution, so that the use of the water sprayer head can be more in line with the urgent needs of consumers.

Although the present invention has been explained in relation to its preferred embodiment, it is to be understood that many other possible modifications and variations can be made without departing from the spirit and scope of invention as hereinafter claimed.

What is claimed is:

1. A water sprayer head comprising a guiding base and a positioning cover; wherein:
the guiding base has a main body with a plurality of guiding columns, each guiding column having a respective central guiding hole and at least one distributing aperture at a front end connected to the guiding hole, a diameter of the distributing aperture being smaller than a diameter of the guiding hole; and
the positioning cover has a front end portion and a rear end portion, the rear end portion has a plurality of sleeve holes corresponding to the number and positions of the guiding columns, each sleeve hole has at least one aperture passing through the front end portion and having a diameter smaller than the diameter of the respective distributing aperture.

2. The water sprayer head as claimed in claim 1, wherein the main body of the guiding base is a round disk.

3. The water sprayer head as claimed in claim 1, wherein the rear end portion of the positioning cover is provided with a groove configured to accept the main body of the guiding base.

4. The water sprayer head as claimed in claim 1, wherein a periphery of the positioning cover has a flange for securing on to water equipment.

5. The water sprayer head as claimed in claim 4, wherein the water equipment is a gardening sprayer.

6. The water sprayer head as claimed in claim 4, wherein the water equipment is a long spray gun.

7. The water sprayer head as claimed in claim 4, wherein the water equipment is a ground sprinkler.
